(19) United States
(12) Patent Application Publication
(10) Pub. No.: US 2025/0315656 A1
(43) Pub. Date: Oct. 9, 2025

(54) UPSCALING LOW-RESOLUTION DOWNHOLE MEASUREMENT DATA USING MACHINE LEARNING MODELS

(71) Applicant: Schlumberger Technology Corporation, Sugar Land, TX (US)

(72) Inventors: Jun Tao MA, Beijing (CN); Lei Kang, Beijing (CN); Yan Song Huang, Beijing (CN); Qing Wang, Beijing (CN); Zhen Wang, Beijing (CN); Mengyu Han, Beijing (CN); Bolei Tan, Beijing (CN); Cheolkyun Jeong, Sugar Land, TX (US)

(21) Appl. No.: 19/098,721

(22) Filed: Apr. 2, 2025

Related U.S. Application Data
(60) Provisional application No. 63/574,310, filed on Apr. 4, 2024.

(51) Int. Cl. G06N 3/0455; E21B 49/00

(52) U.S. Cl. CPC G06N 3/0455; E21B 49/00

(57) ABSTRACT

This disclosure describes a drilling system that uses a resolution transformation system to generate high-resolution target data for one or more types of low-resolution data of a wellbore data log. In various implementations, the resolution transformation system uses a resolution transformation machine learning model that is generated based on high-resolution source data of a different type from the target data and a tool response function associated with the target data. Accordingly, the resolution transformation system efficiently and accurately generates high-resolution target data from the low-resolution target data, which may result in identifying downhole features that would otherwise not be indicated in the low-resolution target data.

### RELATED APPLICATION

This application claims priority to and the benefit of a U.S. Provisional Application having Ser. No. 63/574,310, filed 4 Apr. 2024, which is incorporated by reference herein in its entirety.

### BACKGROUND

Many natural resources are located underground, including water reservoirs and hydrocarbon reservoirs, such as natural gas and oil. To access these resources, downhole drilling systems drill a wellbore along a trajectory path away from a surface location to a target location, formation, or geological feature. Modern drilling systems use measurements underground to determine geological features along the trajectory. However, measurement data in many cases may be of a resolution that is inadequate for sufficiently identifying subsurface features.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 is a representation of a drilling system for drilling an earth formation to form a wellbore.

FIG. 2 illustrates an example subsurface structure system where a resolution transformation system is implemented in connection with a drilling system.

FIG. 3A illustrates example downhole data of various types as well as corresponding tool response functions.

FIG. 3B illustrates a block diagram example of generating low-resolution source data sets from high-resolution source data using different tool response functions.

FIGS. 4A-4B illustrate block diagram examples of training resolution transformation machine learning models with synthetic data within a resolution transformation system to generate high-resolution source data from low-resolution source data.

FIGS. 5A-5B illustrate block diagram examples of using resolution transformation machine learning models to generate high-resolution target data.

FIG. 6 illustrates examples of high-resolution log data generated using a resolution transformation system from low-resolution log data of a wellbore data log.

FIG. 7A illustrates a series of acts of computer-implemented methods for identifying downhole features.

FIG. 7B illustrates a series of acts of computer-implemented methods for generating a resolution transformation machine learning model.

FIG. 8 illustrates example components included within a computer system used to implement the resolution transformation system.

### DETAILED DESCRIPTION

This disclosure describes a drilling system that uses a resolution transformation system to generate high-resolution target data for one or more types of low-resolution data of a wellbore data log. In various implementations, the resolution transformation system uses a resolution transformation machine learning model that is generated based on high-resolution source data of a different type from the target data and based on a tool response function associated with the target data. In this way, the resolution transformation system may efficiently and accurately generate high-resolution target data from the low-resolution target data, for example, to facilitate identifying downhole features that would otherwise not be indicated in the low-resolution target data.

In particular, this disclosure relates to devices, systems, and methods for identifying downhole features using machine learning models, synthetic training data, and/or real-time inputs. In this disclosure, these devices, systems, and methods are described in the context of a resolution transformation system, which may automatically identify low-resolution target data of a first type within a downhole data log and may generate high-resolution target data of the first data type.

To illustrate, in various implementations, the resolution transformation system generates multiple resolution transformation machine learning models to generate sets of high-resolution target data for different data types. For example, based on identifying low-resolution target data of a first data type, the resolution transformation system determines a tool response function associated with the first data type and generates low-resolution data samples of a second data type from high-resolution data samples of the second data type using the determined tool response function. The resolution transformation system uses the low-resolution source data samples and the high-resolution source data samples of the second data type to train a resolution transformation machine learning model to generate high-resolution data samples of the first data type from the low-resolution data samples of the first data type.

As described in this disclosure, the resolution transformation system delivers several significant technical benefits in terms of computing efficiency, accuracy, and flexibility compared to existing systems. Moreover, the resolution transformation system provides practical applications that address problems related to identifying downhole features within low-resolution measurement data of a wellbore data log.

As previously mentioned, existing drilling systems suffer from several problems that result in inefficiencies and inaccuracies. For example, in some instances, subterranean resources may be located in thin bed pay zones having narrow vertical dimensions that may be difficult to identify within many typical downhole measurement data types. For instance, some downhole sensors may be limited in their resolution or sampling frequency, some measurement types may be difficult to obtain at a high frequency, and/or some downhole measurements may be recorded by legacy equipment that exhibits lower-quality resolution. By upscaling lower-resolution target data using a resolution transformation machine learning model based on high-resolution source data that characterizes and quantifies features of the wellbore, thin and/or narrow downhole features may be identified via target data of any number of data types. In many instances, this facilitate the efficient and effective operation of a downhole system for locating, reaching, and accessing underground targets that may otherwise not have been identifiable.

In addition to providing efficiency benefits, the resolution transformation system described herein may ensure that the high-resolution target data is generated accurately in order to facilitate the accurate identification of thin-bed pay zones. For example, different data types may facilitate identifying different underground targets or aspects of underground targets. Thus, while in many cases at least some measurement data may be of a high resolution, having high-resolution data of many different data types provides a more robust and accurate representation of downhole features.

In many instances, the resolution transformation system described herein generates and uses resolution transformation machine learning models (e.g., such as neural networks) to upscale low-resolution data of any type to provide high-resolution measurements of different data types. Moreover, by generating the resolution transformation machine learning model from high-resolution source data captured within the same wellbore and identified from the same wellbore data log, the resolution transformation machine learning model accurately learns features of the wellbore exhibited by the high-resolution source data and may incorporate those features into the upscaling of other, lower-resolution target data with a high degree of precision and accuracy. In this way, the high-resolution target data generated by the resolution transformation system may be reliably implemented for identifying downhole features indicated within the generated data.

Further, the resolution transformation techniques described herein may be implemented in connection with a wellbore data log that includes only limited, or even a single, data type of high-resolution source data. For example, the resolution transformation system generates multiple resolution transformation machine learning models applicable for upscaling multiple types of low-resolution target data, and generates these resolution transformation machine learning models based on the same (e.g., single) high-resolution source data. Using the same high-resolution source data and a unique tool response function applicable to an associated data type, the resolution transformation system may generate a specialized resolution transformation machine learning model for each data type.

Then, using a resolution transformation machine learning model specially trained from a given data type, the resolution transformation system accurately and flexibly generates high-resolution target data from low-resolution samples of the given data type. This provides flexibility for the resolution transforming system to be implemented to upscale any (or all) of the low-resolution data within a downhole data log in order to facilitate identifying downhole features, while only requiring a limited, or even a singular, type of high-resolution source data.

As illustrated in the following discussion, this disclosure uses a variety of terms to describe the features and advantages of one or more implementations described in this disclosure. Additional details are provided to clarify the meaning of some of these terms, while details regarding other terms may be provided later in the document.

As used herein, “wellbore measurement data,” “wellbore data,” and “measurement data” refer to data which each describe an aspect, value, rate, property, state, etc. of some feature detected, observed, or otherwise measured with respect to a downhole operation. For example, the wellbore data may include formation evaluation data such as resistivity data, porosity data, gamma-ray data, density data, acoustic data, seismic data, electromagnetic data, etc. The wellbore data may include drilling parameter data such as flow rate, temperature, pressure, speed, torque (TOR), rate of penetration (ROP), and weight on bit (WOB). The wellbore measurement data may include measurements of formation evaluation, wellbore stability, mud properties, survey data, and equipment health and status. Indeed, the measurement data may include any measurement, metric, or value relevant to a downhole operation, and combinations thereof. The wellbore measurement data may include measurements taken from various downhole and/or surface sensors and/or measurements received from one or more computing devices.

The measurement data may be high-resolution measurement data or low-resolution measurement data. For instance, the term “high-resolution data” may refer to data sampled at a frequency above a threshold, and the term “low-resolution data” may refer to data sampled at a frequency below a (same or different) threshold. In some embodiments, the high-resolution data may refer to data that is sampled in the order of magnitude of samples per inch (# of samples/inch). For example, the high-resolution data may be sampled at 1/in or better. The high-resolution data may be sampled at 0.2/in, 0.4/in, 0.5/in, 1/in, 2/in, 4/in, 5/in, 10/in, or another resolution. The high-resolution data may be data that is sampled with sufficient frequency to capture or indicate thin downhole features as described herein. In some cases, high-resolution data may be resistivity data, ultrasonic data, dielectric data, or another form of high-resolution measurement.

In some embodiments, the low-resolution data may refer to data that is sampled in the order of samples per foot (# of samples/foot). For example, the low-resolution data may be sampled at 2/ft or less. The low-resolution data may be sampled at 2/ft, 1.5/ft, 1/ft, 0.5/ft, or another resolution. The low-resolution data may be data that is sampled with a frequency insufficient to adequately capture or indicate thin downhole features as described herein. Unless stated otherwise, low-resolution data of a given data type is always sampled less frequently over the same distances than high-resolution data of the given type. Often high-resolution data is sampled at least three or more times as frequently as low-resolution data of the same type. As described herein, high-resolution data may be generated, upscaled, or otherwise transformed from corresponding low-resolution data by a resolution transformation system.

As used herein, a “log” such as a data log, wellbore data log, or downhole data log may refer to data contained or documented within an operation report or log for a downhole operation. For example, the wellbore data logs may document the various measurements taken during or in pursuit of one or more downhole operations. The logs may document relevant times and/or depths of the measurements. In some cases, the downhole logs may be generated or aggregated manually, such as by a drilling engineer compiling various measurement data for a downhole operation. The logs may be generated while downhole (e.g., drilling) activities are being conducted, or may be generated after the completion of one or more activities such as part of an upload or transmission of various data for one or more downhole activities.

As used herein, a “feature” such as a geological feature or downhole feature may be any element of a geological formation. A geological feature may include a reservoir, pay zone, subterranean target, or any other underground feature for which it may be desirable to know its location, orientation, position, etc. For instance, a geological feature may include a geological structure, such as a formation. A feature may include the entire geological structure. A downhole feature may include a volume of space, including one or more structures, rock types, material types, and so forth. In some embodiments, a feature may include a boundary between two geological structures, such as a boundary between strata. In some embodiments, a feature may include a boundary between rock types. In some embodiments, a downhole feature may include a specific structure of a set of structures, such as a fluid reservoir. A feature may be 3-dimensional. For example, a feature may include a 3-dimensional surface having variations in latitude, longitude, and depth. In some embodiments, a feature may be a reservoir, pay zone, or underground resource, such as an oil, gas, or water reservoir, a source of geothermal energy, or any other subterranean target.

As used herein, a reservoir, pay zone, subterranean target, or downhole feature being described as “thin,” “narrow,” or the like (e.g., a thin-bed pay zone, narrow reservoir, etc.) refers to an underground feature, target, resource, etc. that has a dimension (e.g., a vertical dimension) and/or orientation that makes it difficult to identify within corresponding downhole measurement data. For example, a thin-bed reservoir may have a vertical dimension such that, given the resolution of a specific downhole measurement tool, an associated measurement from the tool may not indicate the reservoir, may indicate the reservoir to a lesser, insubstantial, or insignificant degree, may indicate the reservoir as an outlier, or may indicate features of the reservoir as a property average with features of neighboring formations. For instance, a thin-bed reservoir may have a vertical dimension that is substantially the same as, or shorter than, a resolution of a downhole measurement tool. In another example, a thin-bed reservoir may have a vertical dimension that is some other proportion to the resolution of a downhole tool that makes it difficult to identify the reservoir. In another example, a downhole feature may have a vertical dimension that is missing from low-resolution measurement data.

As used herein, a “tool response function,” or “tool response filter” refers to a mathematical relationship between a measured signal and an associated formation property being evaluated. The function describes how the output signal from the measurement tool corresponds to the physical properties of the formation being measured. For example, when a measurement or logging tool is implemented in a wellbore to measure properties such as resistivity, porosity, density, etc. the measurements it records are influenced by various factors including tool design, tool calibration, environmental conditions, wellbore features, the properties of the formation itself, etc.

Tool response functions may incorporate, characterize, or reflect these influences and may define how the measured signal relates to one or more specific formation properties. A tool response function may facilitate accurately interpreting the measurement data and identifying meaningful information about the subsurface formation from the measurement data. In some cases, a tool response function may be applicable to, may be unique to, or may otherwise be associated with a specific measurement tool, a specific type of measurement data, a specific data channel, or a specific wellbore, and combinations thereof. For example, a wellbore data log may include a variety of different types of measurement data, and a collection of tool response functions may be defined for applying to and interpreting the different types of measurement data, with each tool response function applying to a specific type (or several types) of the measurement data.

As used herein, “machine-learning model” refers to a computer model or computer representation that may be trained (e.g., optimized) based on inputs to approximate unknown functions. For instance, a machine-learning model may include, but is not limited to, a neural network (e.g., a convolutional neural network (CNN) or deep learning model), a decision tree (e.g., a gradient-boosted decision tree), a linear regression model, a logistic regression model, or a combination of these models.

As another example, the term “neural network” refers to a machine learning model comprising interconnected artificial neurons that communicate and learn to approximate complex functions, generating outputs based on multiple inputs provided to the model. For instance, a neural network includes an algorithm (or set of algorithms) that employs deep learning techniques and uses training data to adjust the parameters of the network and model high-level abstractions in data. Various types of neural networks exist, such as convolutional neural networks (CNNs), residual learning neural networks, recurrent neural networks (RNNs), generative neural networks, generative adversarial neural networks (GANs), and single-shot detection (SSD) networks. In one or more examples herein, a neural network may be implemented as an autoencoder model, such as a model which learns an encoding function that transforms input data and a decoding function that recreates the input data from the encoded representation.

Additional terms are defined throughout the disclosure in connection with various examples and contexts.

Turning now to the figures, additional details are provided regarding the components and features of the resolution transformation system. Additional example implementations and details of the resolution transformation system are discussed in connection with the accompanying figures.

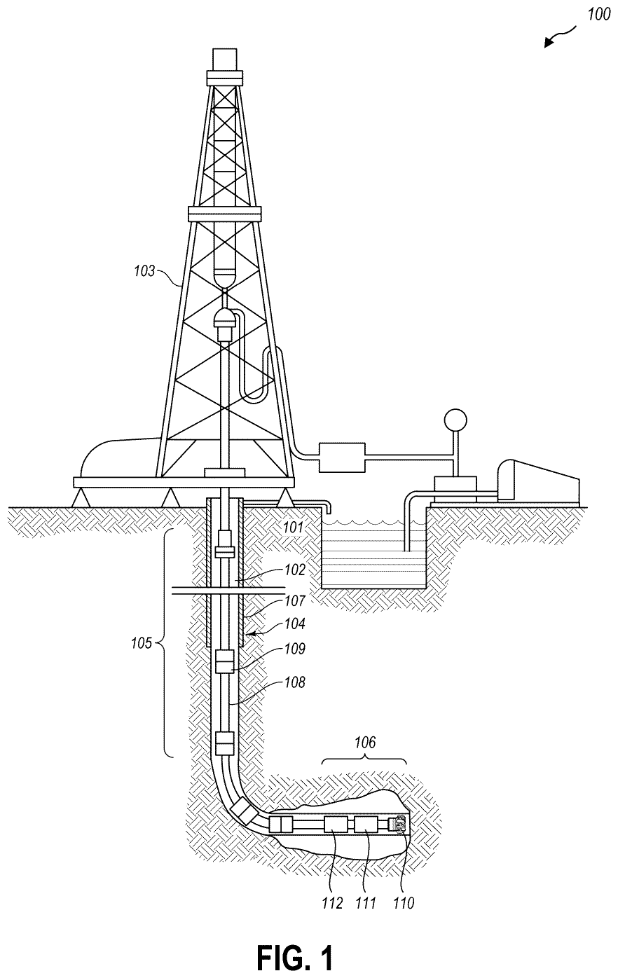

FIG. 1 shows an example representation of a drilling system for drilling an earth formation to create a wellbore. FIG. 1 provides context regarding a drilling system to which the resolution transformation system often belongs. To illustrate, FIG. 1 shows one example of a drilling system 100 used for drilling an earth formation 101 to form a wellbore 102. The drilling system 100 includes a drill rig 103 used to rotate a drilling tool assembly 104 that extends downward into the wellbore 102. The drilling tool assembly 104 may include a drill string 105, a bottomhole assembly (BHA 106), and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through nozzles, jets, or other openings in the bit 110 for purposes such as cooling the bit 110 and its cutting structures, lifting cuttings out of the wellbore 102 during drilling, controlling fluid influx in the well, maintaining wellbore integrity, and other functions.

The BHA 106 may include the bit 110 or other components. An example BHA 106 may include additional or different components (e.g., coupled between the drill string 105 and the bit 110). Examples of additional BHA components include drill collars, stabilizers, measurement-while-drilling (MWD) tools, logging-while-drilling (LWD) tools, downhole motors, underreamers, section mills, hydraulic disconnects, jars, vibration or damping tools, other components, or combinations of these components.

The BHA 106 may further include a directional tool 111 such as a bent housing motor or a rotary steerable system (RSS). The directional tool 111 may include directional drilling equipment that changes the direction of the bit 110, thereby altering the trajectory of the wellbore 102. In some cases, at least a portion of the directional tool 111 may maintain a geostationary position relative to an absolute reference frame, such as gravity, magnetic north, or true north. Using measurements obtained from this geostationary position, the directional tool 111 may locate the bit 110, modify its course, and guide the directional tool 111 along a projected trajectory. For instance, the BHA 106 (including the directional tool 111) is shown transitioning from vertical to horizontal drilling, causing the bit 110 to move along a horizontal path away from the drill rig 103.

In general, the drilling system 100 may include additional or different drilling components and accessories including special valves (e.g., blowout preventers and safety valves). Additional components within the drilling system 100 may be categorized as part of the drilling tool assembly 104, the drill string 105, or part of the BHA 106 depending on their specific locations within the drilling system 100.

The bit 110 in the BHA 106 may be any type of bit suitable for degrading downhole materials such as the earth formation 101. Examples of drill bits used for drilling earth formations include fixed-cutter or drag bits, roller cone bits, and combinations thereof. In other embodiments, the bit 110 may be a mill used for removing metal, composite, elastomer, or other downhole materials, or combinations thereof. For instance, the bit 110 may be used with a whipstock to mill into the casing 107 lining the wellbore 102. The bit 110 may also be a junk mill used to mill away tools, plugs, cement, or other materials within the wellbore 102, or combinations thereof. Swarf or other cuttings formed by the use of a mill may be lifted to the surface or allowed to fall downhole. In still other embodiments, the bit 110 may include a reamer. For instance, an underreamer may be used in connection with a drill bit, and the drill bit may bore into the formation while the underreamer enlarges the size of the bore.

While performing downhole activities, a subsurface structure system may receive information regarding the earth formation 101 based on one or more sets of survey data. For example, the BHA 106 may include downhole tool sensors 112 (e.g., an LWD tool). The downhole tool sensors 112 may collect downhole measurement data about the earth formation 101. The downhole measurement data may be collected by transmitting to the surface and may be assembled in a wellbore data log.

Downhole measurement data may be used to determine the geological properties of the earth formation 101. For example, the downhole tool sensors 112 may include resistivity sensors, porosity sensors, density sensors, gamma ray sensors, etc., and may be used to determine one or more geological surfaces, structures downhole features, etc. The downhole measurement data includes one or more instances of high-resolution data and often multiple instances low-resolution data across a variety of data and measurement types.

As described in this disclosure, a resolution transformation system may use one or more types of high-resolution measurement data of a wellbore data log, such as resistivity data, to facilitate upscaling the resolution of other measurement data of the wellbore data. In particular, the resolution transformation system uses one or more machine learning models (e.g., a resolution transformation machine learning model) to accurately generate high-resolution measurement data for data that was otherwise measured at a low resolution.

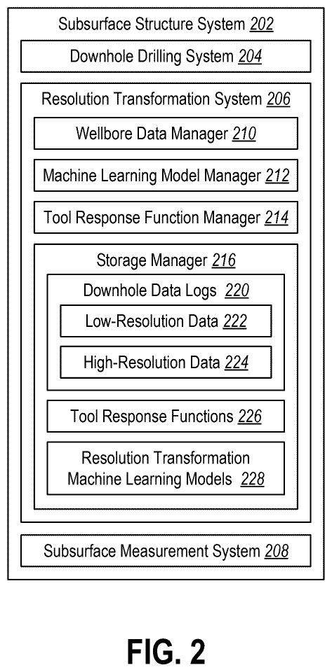

With the framework of the drilling system and an example operating environment described, this disclosure will now focus on describing implementations of the resolution transformation system. To illustrate, FIG. 2 shows an example of a subsurface structure system 202 implementing a resolution transformation system 206. The subsurface structure system 202 includes various computing devices and systems. As shown, the subsurface structure system 202 includes a downhole drilling system 204, the resolution transformation system 206, and a subsurface measurement system 208. Each of these systems may be implemented on one or more computing devices.

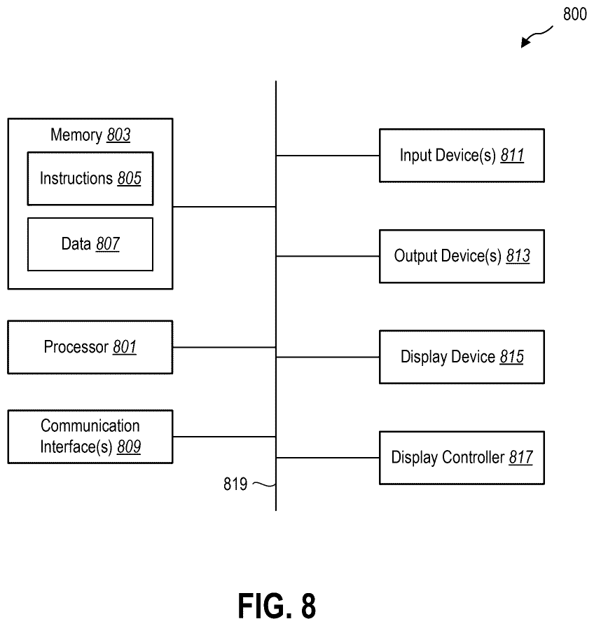

The subsurface structure system 202 may include additional devices and components not shown. Additionally, while FIG. 2 shows example arrangements and configurations of the subsurface structure system 202 and/or the resolution transformation system 206, other arrangements and configurations are possible. Further, details regarding computing devices are provided below in connection with FIG. 8.

In various implementations, the downhole drilling system 204 precisely controls the direction and trajectory of a drill and/or wellbore as it progresses through the subsurface formations. In various instances, a downhole drilling system 204 uses real-time data analysis with precise drilling control to navigate through subsurface formations, maximize reservoir contact, minimize drilling risks, and optimize the placement of wellbores in hydrocarbon reservoirs. The downhole drilling system 204 operates in connection with the resolution transformation system 206, for example, to steer or direct the trajectory based on downhole features identified from generated high-resolution measurement data from the resolution transformation system.

In some implementations, the subsurface measurement system 208 uses one or more tools to collect and analyze data from below the Earth's surface. The subsurface measurement system 208 may use various instruments and methods designed for measuring and monitoring conditions, properties, and processes in subsurface environments, such as underground reservoirs, geological formations, and aquifers. In various implementations, a subsurface measurement system 208 includes sensors, probes, well-logging equipment, and remote sensing technologies to provide subsurface information.

As shown, the subsurface structure system 202 includes the resolution transformation system 206, which may communicate with the downhole drilling system 204 and the subsurface measurement system 208. The resolution transformation system 206 includes various components to implement the functions, features, systems, and methods described in this document. To illustrate, the resolution transformation system 206 includes a wellbore data manager 210, a machine learning model manager 212, a tool response function manager 214, and a storage manager 216. The storage manager 216 includes downhole data logs 220, which includes low-resolution data 222 and high-resolution data 224. The storage manager 216 additionally includes tool response functions 226, and resolution transformation machine learning models 228. The resolution transformation system 206 may include additional or different components, as previously mentioned above.

The resolution transformation system 206 may be located as part of a downhole assembly, located at the surface, or located at various locations. For example, in some instances, the resolution transformation system 206 is located near a downhole tool sensor, near the bit, near the BHA, etc. and upscales the resolution of measurement data in real-time as data is received. In some implementations, the resolution transformation system 206 is implemented at the surface to generate high-resolution measurement data and facilitate identifying downhole features within the data.

In various implementations, the wellbore data manager 210 obtains the downhole data logs 220 including low-resolution data 222 and high-resolution data 224 from the subsurface measurement system 208. In many instances, the wellbore data manager 210 obtains the downhole data logs 220 in real time. The wellbore data manager 210 may provide the downhole data logs 220 to the machine learning model manager 212 to generate high-resolution data from some or all of the low-resolution data 222. In some instances, the wellbore data manager 210 updates the downhole data logs 220 with high-resolution target data generated from low-resolution data of the same data type, as described below.

In various implementations, the machine learning model manager 212 receives a tool response function from the tool response function manager 214. For example, based on a type of data to be upscaled by the machine learning model manager 212, the tool response function manager 214 may identify a corresponding tool response function for that data type from the tool response functions 226.

In various implementations, based on the high-resolution data 224, and based on an identified tool response function corresponding to the low-resolution data 222 to be upscaled, the machine learning model manager 212 may generate corresponding high-resolution data 224 from the low-resolution data 222. For instance, the machine learning model manager 212 may use one or more of the resolution transformation machine learning models 228 to generate the high-resolution data based on features (e.g., wellbore features, formation features, tool features) learned by the resolution transformation machine learning model(s).

The resolution transformation machine learning models 228 may include different types of resolution transformation machine learning models, such as image segmentation machine-learning models with neural network architectures (e.g., Monte Carlo Dropout prediction model, U-Net, U-Net++, Mask R-CNN, transformer-based models, large generative model-based segmentation neural networks, etc.). The machine learning model manager 212 may update the downhole data logs 220 with the upscaled high-resolution versions of the low-resolution data 222. This generated high-resolution data 224 may facilitate identifying downhole features such as thin-bed pay zones that may otherwise have been unidentifiable within the low-resolution data 222.

Each of the components of the subsurface structure system 202 and/or the resolution transformation system 206 may be implemented in software, hardware, or both. For example, the components of the resolution transformation system 206 include instructions stored on a computer-readable storage medium and executable by at least one processor of one or more computing devices. When executed by the processor, the computer-executable instructions of the subsurface structure system 202 cause a computing device to perform the methods described herein. As another example, the components of the resolution transformation system 206 include hardware, such as a special-purpose processing device to perform a certain function or group of functions. In some instances, the components of the resolution transformation system 206 include a combination of computer-executable instructions and hardware.

Furthermore, the components of the subsurface structure system 202 and/or the resolution transformation system 206 may be implemented as one or more operating systems, stand-alone applications, modules of an application, plug-ins, library functions, functions called by other applications, and/or cloud-computing models. Additionally, the components of the resolution transformation system 206 may be implemented as one or more web-based applications hosted on a remote server and/or implemented within a suite of mobile device applications or “apps.”

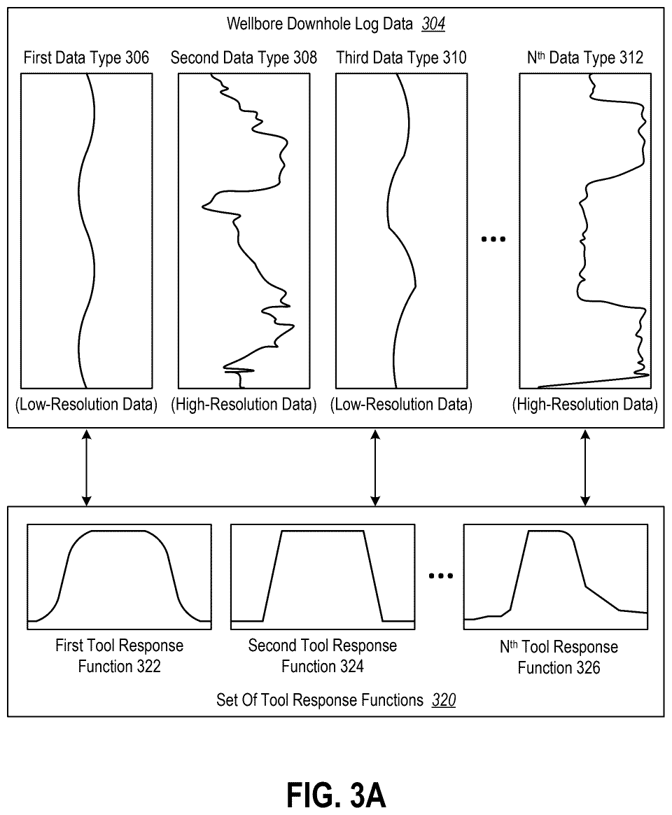

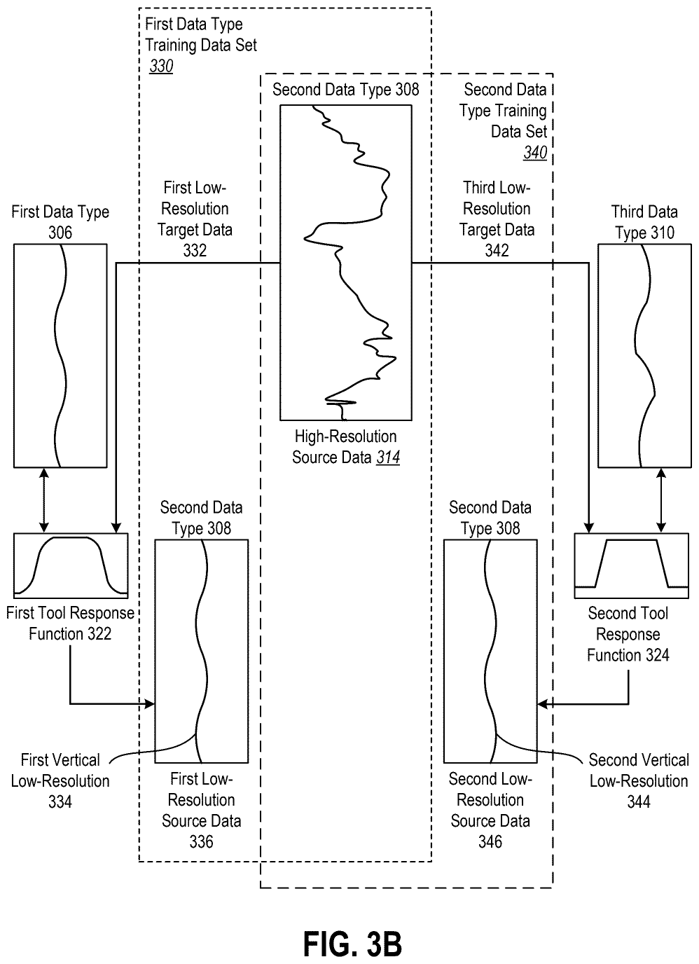

As previously mentioned, the resolution transformation system 206 receives and/or accesses downhole data logs, as well as identifies and provides tool response functions corresponding to data types. To illustrate, FIG. 3A illustrates example downhole data of various types as well as corresponding tool response functions according to some implementations. In particular, FIG. 3A illustrates an example of wellbore downhole log data 304 having various types of downhole data, as well as corresponding sets of tool response functions 320.

In some embodiments, the wellbore downhole log data 304 includes a variety of types of data. For instance, the wellbore downhole log data 304 may include formation evaluation data such as resistivity data, porosity data, gamma-ray data, etc. The wellbore downhole log data 304 may include drilling parameter data such as flow rate, pressure, temperature, rotational speed, torque, weight on bit, etc. These various types of data may be represented by the various data types of the wellbore downhole log data 304 as illustrated in FIG. 3A. For example, the wellbore downhole log data 304 may include data of a first data type 306, a second data type 308, a third data type 310, and any number of additional data types to an nth data type 312. Each data type 306-312 of the wellbore downhole log data 304 may be a different type of measurement data.

In various examples, the wellbore downhole log data 304 may be measured and/or received as time-series data. In some embodiments, the wellbore downhole log data 304 may be measured and/or received as data in a depth domain. In some cases, the resolution transformation system 206 may transform some or all of the wellbore downhole log data 304 between a time domain and a depth domain. In some embodiments, the wellbore downhole log data 304 (and/or any of the measured or generated data described herein) may be depth-independent.

To illustrate, the wellbore downhole log data 304 may be accumulated or aggregated as a collection of measurements irrespective of a depth at which the measurements were taken. For instance, measurements or properties observed or captured by the associated data may not be conveyed with respect to a depth at which the measurements were observed. The wellbore downhole log data 304 being depth-independent may facilitate the techniques described herein by facilitating direct comparison between, interpretation of, and/or analysis of features of the data taken at different depths without correcting or adjusting for depth. In some embodiments, the resolution transformation system 206 may convert some or all of the data available to it to be depth independent as described, and/or may convert some or all of the data back to a depth domain such as to identify a location (e.g., depth) of identifiable features in generated high-resolution data.

The wellbore downhole log data 304 may include measurement data of various resolutions. For example, the first data type 306 and the third data type 310 may be low-resolution data (e.g., with the same or different resolution granularities). For instance, these data types may be sampled at a low-resolution rate due to limitations of corresponding measurement tools. The second data type 308 may be high-resolution data. In some embodiments, the second data type 308 is resistivity data. The specific resolutions of the various types of measurement data shown in FIG. 3A are merely illustrative, and any data type may be taken at any resolution. In some embodiments, the nth data type 312 may be high-resolution data. In some implementations, each type of data that is described as low-resolution data may have the same (low) resolution or may have different resolution granularities (e.g., 0.5/ft and 1/ft). Similarly, each data type described as high-resolution data may have the same (high) resolution or may have different resolutions.

In various implementations, a set of tool response functions 320 may be defined which may correspond to the various data of the wellbore downhole log data 304. For instance, the set of tool response functions 320 may include a first tool response function 322, a second tool response function 324, and any number of additional tool response functions to an nth tool response function 326. As described herein, the tool response functions may describe, define, and/or associate various relationships, features, behaviors, etc., associated with how the wellbore downhole log data 304 may measure various aspects of the formation.

In some embodiments, each tool response function may correspond to a specific data type of the wellbore downhole log data 304. For example, the first tool response function 322 may be distinctly associated with the first data type 306, the second tool response function 324 may distinctly apply to the second data type 308, etc. For example, the first data type 306 corresponds to the first tool response function 322, the third data type 310 corresponds to the second tool response function 324, and the nth data type 312 corresponds to the nth tool response function 326. While not shown, each data type may have an associated tool response function. In various instances, multiple data types correspond to the same tool response function. In some embodiments, a subset of the data types may have corresponding tool response functions, such as only the low-frequency data types, only the high-frequency data types, or any other subset of the wellbore downhole log data 304.

FIG. 3B illustrates a block diagram example of generating low-resolution source data sets from high-resolution source data using different tool response functions. As described herein, the low-resolution source data sets may be utilized as training data for generating resolution transformation machine learning models.

For example, the wellbore downhole log data 304 may include the first low-resolution target data 332 of a first data type 306. In some cases, the resolution transformation system 206 may be implemented to generate a high-resolution version of the first low-resolution target data 332, and the resolution transformation system 206 may be implemented to upscale the first low-resolution target data 332. Accordingly, the first low-resolution source data 336 may be generated to correspond to and/or be associated with the first data type 306. For instance, based on the first low-resolution target data 332 having the first data type 306, the resolution transformation system 206 may select a first tool response function 322.

The first tool response function 322 may uniquely correspond to the first data type 306. For example, the first tool response function 322 may incorporate unique features associated with the first data type (e.g., features of an associated measurement tool) and may represent those unique features through a mathematical relationship of the first tool response function 322. In some instances, the first tool response function 322 is shared with multiple similar data types.

The resolution transformation system 206 may implement the first tool response function 322 in connection with the second high-resolution source data 314 (e.g., may apply a filter based on the first tool response function 322 to the second high-resolution source data 314) in order to generate the first low-resolution source data 336. In this way, the first low-resolution source data 336 may be a low-resolution version of the second high-resolution source data 314 that is generated based on features of the first data type 306 as incorporated by the first tool response function 322. In this way, a comparison of the first low-resolution source data 336 to the second high-resolution source data 314 (e.g., during training of an associated resolution transformation machine learning model) may indicate these unique features of the first data type 306 by implementing the first tool response function 322, and may also indicate unique features of the wellbore, formation, downhole operation, etc., by the high-resolution measurements of the second high-resolution source data 314.

In some embodiments, the first low-resolution target data 332 may have a first vertical low resolution 334, and the first low-resolution source data 336 may be generated to have the same resolution as the first vertical low resolution 334. For example, the first tool response function 322 (e.g., applied as a filter) may facilitate generating the first low-resolution source data 336 at the first vertical low resolution 334. In another example, the first low-resolution source data 336 may be generated with a different vertical low resolution. The first low-resolution source data 336 may be further modified to match the first vertical low resolution 334 such as through interpolation, downsampling or upsampling, filtering, smoothing, averaging, or any other form of resolution transformation.

In some embodiments, the wellbore downhole log data 304 may include third low-resolution target data 342 of the third data type 310, and the resolution transformation system 206 may similarly be implemented to generate a high-resolution version of the third low- resolution target data 342. The resolution transformation system 206 may generate second low-resolution source data 346 from the second high-resolution source data 314 similar to that described in connection with the first low-resolution source data 336. For example, the resolution transformation system 206 may select and implement a second tool response function 324 for generating the second low-resolution source data 346 from the second high-resolution source data 314.

The second tool response function 324 may be associated with the third data type 310 of the third low-resolution target data 342. In this way, the second low-resolution source data 346 may be generated based on unique characteristics of the third data type 310 as incorporated via the second tool response function 324 as well as include the inherent features of the wellbore embedded in the second high-resolution source data 314. Additionally, the third low-resolution target data 342 may have a second vertical low resolution 344 and the second low-resolution source data 346 may be made to have the second vertical low resolution or a different resolution. The second vertical low resolution 344 may be the same as the first vertical low resolution 334 or may be a different resolution.

In this way, the resolution transformation system 206 may generate one, or several sets of low-resolution source data (e.g., first low-resolution source data 336 and second low-resolution source data 346), with each set being uniquely applicable to a specific data type and/or a specific set of low-resolution target data. Additionally, each of the sets of low-resolution source data may be generated from the same set of high-resolution source data. For instance, the second high-resolution source data 314 may be implemented in connection with any number of different tool response functions to generate any number of different sets of low-resolution source data for associated data types.

In some implementations, a wellbore log includes multiple sets of high-resolution data of different data types. In these instances, the resolution transformation system 206 may generate multiple sets of low-resolution source data for the same target data type. For example, the resolution transformation system 206 applies the first tool response function associated with the first data type to multiple high-resolution source data sets of different data types to generate multiple first low-resolution source data sets applicable to the first data type but generated from the different data types of the multiple high-resolution source data sets. As described below, the resolution transformation system 206 may use the multiple low-resolution source data sets corresponding to the first data type and generated from high-resolution source data sets of multiple different data types to train a resolution transformation machine learning model for the first data type.

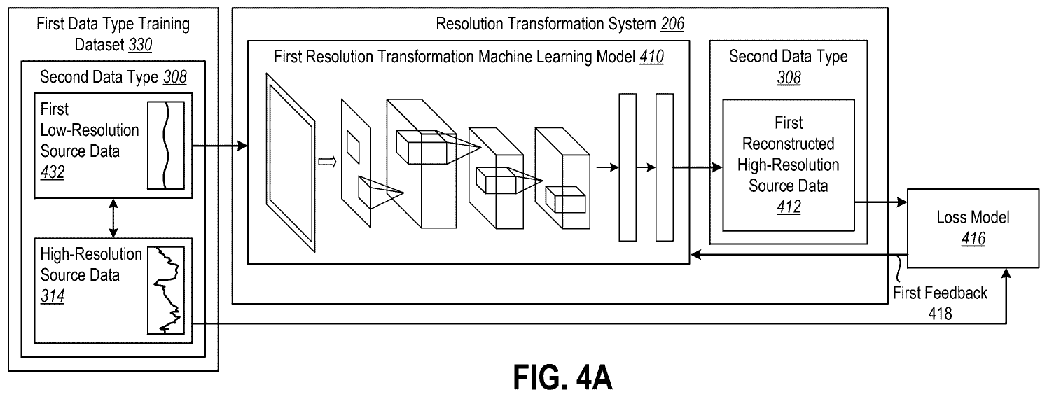

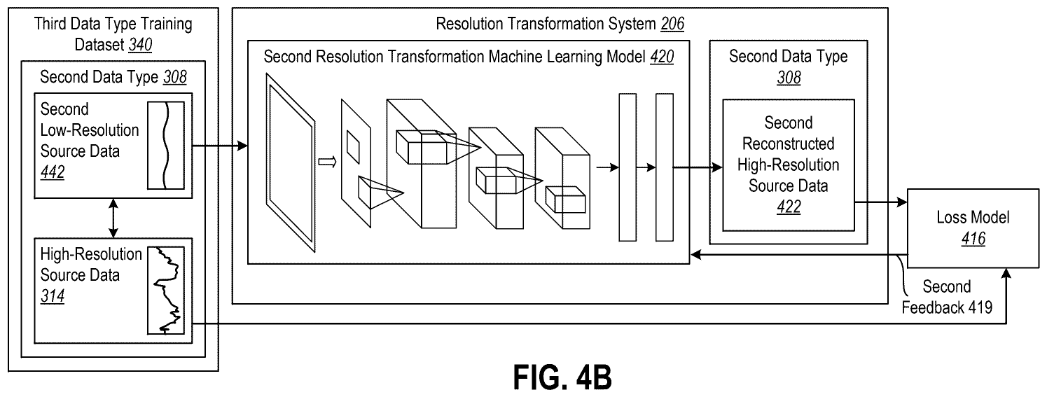

As mentioned above, the low-resolution source data may be implemented as training data for training resolution transformation machine learning models of the resolution transformation system 206. Accordingly, FIGS. 4A-4B illustrate an example block diagram of training resolution transformation machine learning models with synthetic data within a resolution transformation system to generate high-resolution source data according to some implementations. The resolution transformation system 206 may train and generate a first resolution transformation machine learning model 410 and a second resolution transformation machine learning model 420.

The first resolution transformation machine learning model 410 may be generated to upscale, or generate high-resolution versions of wellbore measurement data of the first data type 306. For example, as shown, FIG. 4A includes the first data type training dataset 330, the first resolution transformation machine learning model 410, and a loss model 416. The first data type training dataset 330 includes the first low-resolution source data 432 of the second data type 308 and the second high-resolution source data 314 corresponding to the first low-resolution source data 432. In some implementations, the first low-resolution source data 432 is the first low-resolution source data 336 discussed above in connection with FIG. 3B.

In various implementations, such as the one shown in FIG. 4A, the first resolution transformation machine learning model 410 includes a neural network architecture, such as higher and lower neural network layers. For example, the first resolution transformation machine learning model 410 may be an autoencoder neural network with a feature vector encoder and decoder, similar to one or more of the machine-learning model types described above. In various instances, the first resolution transformation machine learning model 410 is a Monte Carlo Dropout prediction model, a U-Net neural network, or a U-Net++ neural network. In some instances, the first resolution transformation machine learning model 410 is a large generative model, such as a large generative model (LGM) or a multi-modal image-to-image neural network.

To elaborate, in some instances, the first resolution transformation machine learning model 410 is a convolutional neural network (CNN) that includes several neural network layers, such as lower neural network layers that form an encoder, and higher neural network layers that form a decoder. For example, the encoder maps or encodes input source data into feature vectors (i.e., latent object feature maps or latent object feature vectors) by processing the input source data through various neural network layers (e.g., convolutional, ReLU, and/or pooling layers) to encode measurement data and various other aspects from the input source data into feature vectors (e.g., a string of numbers in vector space representing the encoded image data). For instance, the encoder of a resolution transformation machine learning model processes input source data to encode data features corresponding to formation changes, downhole features, and/or reservoir boundaries from the first low-resolution source data 336.

Additionally, in various implementations, the first resolution transformation machine learning model 410 includes higher neural network layers that form a decoder, which may include fully connected layers and/or a classifier function (e.g., a SoftMax or a sigmoid function). In these implementations, the decoder processes the feature vectors to decode detected downhole features and/or thin-bed reservoirs in an encoded data vector and generate the first reconstructed high-resolution source data 412 that may indicate features of the first low-resolution source data 432 at a high resolution.

As shown, the first resolution transformation machine learning model 410 generates the first reconstructed high-resolution source data 412. The first reconstructed high-resolution source data 412 indicates features associated with the first low-resolution source data 432 but at a higher resolution. In some embodiments, the first reconstructed high-resolution source data 412 may indicate one or more features that were latent, unidentifiable, or that may not have even been indicated or apparent in the first low-resolution source data 432.

As shown in FIG. 4A, the loss model 416 is included, which may have one or more loss functions (e.g., mean square error (MSE), cross-entropy loss, and/or data similarity loss). In various implementations, the resolution transformation system 206 uses the loss model 416 to determine an error or loss amount, which the resolution transformation system 206 provides back to the first resolution transformation machine learning model 410 as first feedback 418 to train and fine-tune the first resolution transformation machine learning model 410.

To further elaborate, in various implementations, the resolution transformation system 206 compares the second high-resolution source data 314 to the first reconstructed high-resolution source data 412 using the loss model 416 to generate the first feedback 418 indicating an error or loss amount (e.g., an MSE amount). The first reconstructed high-resolution source data 412 is generated by the first resolution transformation machine learning model 410 based on the first low-resolution source data 432 corresponding to the second high-resolution source data 314.

Additionally, in one or more implementations, the resolution transformation system 206 uses the first feedback 418 to train, optimize, and/or fine-tune the neural network layers of the resolution transformation machine learning models through techniques like backpropagation and/or end-to-end learning. In some implementations, the resolution transformation system 206 uses an optimizer algorithm such as the Adam optimizer and/or another optimization algorithm for stochastic gradient descent (SGD) to train the deep learning models. Furthermore, the resolution transformation system 206 may iteratively fine-tune and train the resolution transformation machine learning models until they converge, for a set number of iterations, until the training data is exhausted, or until a satisfactory level of accuracy is achieved.

In various implementations, the resolution transformation system 206 uses different data augmentation techniques and n-fold ensembles. For instance, the resolution transformation system 206 augments the first data type training dataset 330 to increase the robustness of the resolution transformation machine learning models. For example, the resolution transformation system 206 creates instances of the first data type training dataset 330 that are horizontally and/or vertically flipped, randomly segmented and/or reordered, modified based on random Gaussian noise values, or otherwise randomly adjusted.

As shown in FIG. 4B, the resolution transformation system 206 may train and generate a second resolution transformation machine learning model 420. In a similar manner to that described above in connection with the first resolution transformation machine learning model 410, the second resolution transformation machine learning model 420 may be generated to upscale, or generate high-resolution versions of, wellbore measurement data of the third data type 310 (which is different from the first data type). The second resolution transformation machine learning model 420 may include any of the approaches and actions used to generate and/or train the first resolution transformation machine learning model 410 described herein.

For instance, the resolution transformation system 206 may provide a second low-resolution source data 442 of the second data type 308 to the second resolution transformation machine learning model 420. In some cases, the second low-resolution source data 442 may be the second low-resolution source data 346 described above in connection with FIG. 3B. The second resolution transformation machine learning model 420 may process the second low-resolution source data 442 through various network layers to encode feature vectors representing the second low-resolution source data 442, and may further process the feature vectors through various higher network layers to decode data features and generate second reconstructed high-resolution source data 422. Using the loss model 416, the resolution transformation system 206 may compare the second reconstructed high-resolution source data 422 to the second high-resolution source data 314 and may provide second feedback 419 to the second resolution transformation machine learning model 420 to further train and fine tune the second resolution transformation machine learning model 420.

In this way, the resolution transformation system 206 may train and generate the second resolution transformation machine learning model 420 for generating high-resolution data for input data of the third data type 310. The resolution transformation system 206 may generate any number of resolution transformation machine learning models for upscaling measurement data of any number of different data types.

Additionally, while the resolution transformation machine learning models have been shown and described as being trained and generated based on low-resolution source data generated from a single source of high-resolution source data, in various implementations and as mentioned above, one or more resolution transformation machine learning models may be trained based on multiple sources of high-resolution source data. In this way, the resolution transformation machine learning model may generate any number of resolution transformation machine learning models for upscaling data of any number of different data types and may generate these machine learning models based on one or multiple sources of available high-resolution data.

To elaborate, a wellbore downhole log may include several types of data that were recorded or measured in a high resolution, and one or more types of data that were recorded or measured in a low resolution. The resolution transformation system 206 may accordingly generate several sets of low-resolution source data from the multiple types of high-resolution data by implementing a tool response function as described herein with respect to the several different sources of high-resolution data (e.g., a tool response function associated with a specific low-resolution data type for which a resolution transformation machine learning model is to be generated). The resolution transformation system 206 may provide these several sets of low-resolution source data for training a dedicated resolution transformation machine learning model and may accordingly implement the associated high-resolution data as ground truth data for providing feedback to the resolution transformation machine learning model to further train and fine tune the model.

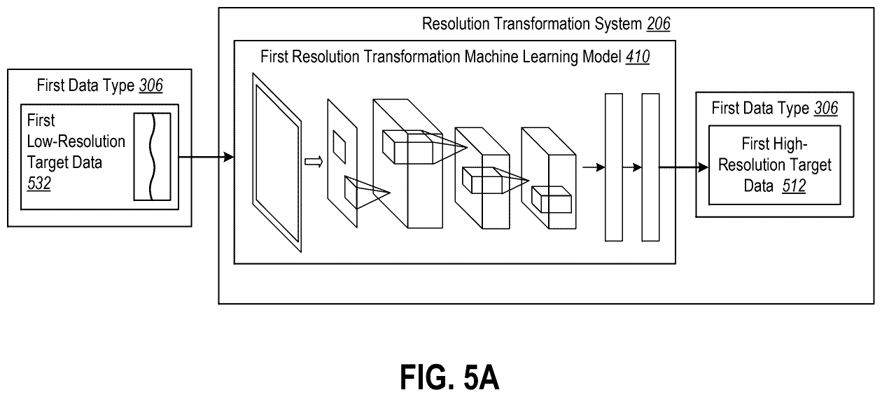

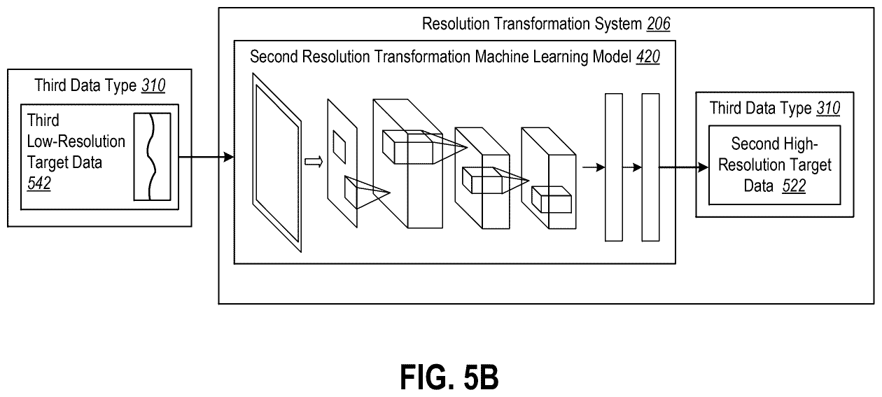

Once trained, in various implementations, the resolution transformation system 206 uses the resolution transformation machine learning models to automatically generate high-resolution target data from low-resolution target data. FIGS. 5A-5B illustrate block diagram examples of using resolution transformation machine learning models to generate high-resolution target data.

As shown, in FIGS. 5A-5B, the resolution transformation system 206 includes the first resolution transformation machine learning model 410 and the second resolution transformation machine learning model 420. In these figures, the first resolution transformation machine learning models 410 and the second resolution transformation machine learning model 420 represent trained models with tuned neural network layers and other trained components. The first resolution transformation machine learning model 410 generates the first high-resolution target data 512 of the first data type 306 from the first low-resolution target data 532 of the first data type 306. The second resolution transformation machine learning model 420 generates second high-resolution target data 522 of the third data type 310 from third low-resolution target data 542 of the third data type 310.

In various implementations, the low-resolution target data includes real-time data. For example, as the resolution transformation system 206 receives measurement data and/or wellbore logs, the resolution transformation system 206 upscales and/or generates corresponding high-resolution target data from the low-resolution target data. The resolution transformation system 206 may then efficiently and accurately augment or update the wellbore logs with high-resolution target data in real time using the resolution transformation machine learning models and other components.

In some implementations, the low-resolution target data corresponds to different types of data. In one example, the low-resolution target data includes porosity data. In another example, the low-resolution target data includes gamma-ray data, neutron density data, or any other type of measurement data taken or measured as a low resolution. The resolution transformation machine learning models may be generated and implemented to generate corresponding high-resolution data for any type of measurement data included in a wellbore data log.

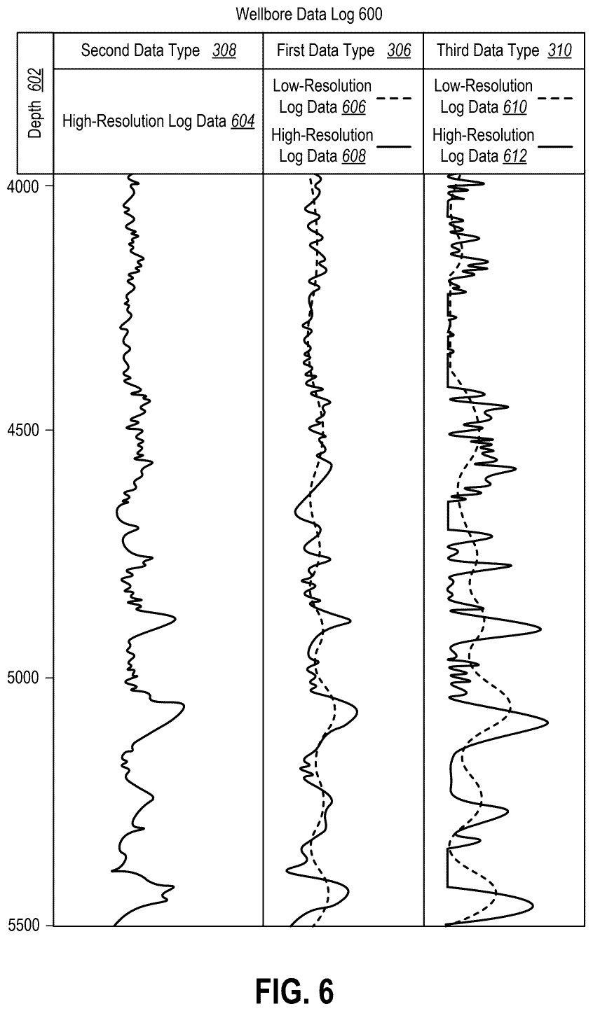

FIG. 6 illustrates examples of high-resolution log data generated using a resolution transformation system from low-resolution log data of a wellbore data log 600. The wellbore data log 600 may include measurement data of various types. For instance, the wellbore data log 600 may include data of a first data type 306, a second data type 308, and a third data type 310. The wellbore data log 600 may include any number of different types of data.

The data of the wellbore data log 600 may be of varying resolutions. For example, the wellbore data log 600 may include low-resolution log data 606 of the first data type 306. The wellbore data log 600 may include low-resolution log data 610 of the third data type 310. In some implementations, the low-resolution log data 606 and the low-resolution log data 610 are each measurement data that were measured or recorded at a low resolution. The low resolution of the low-resolution log data 606 and the low-resolution log data 610 may be the same low resolution or may be different low resolutions.

In various implementations, the wellbore data log 600 includes high-resolution log data 604 of the second data type 308. The high-resolution log data 604 may be measurement data that was measured or recorded at a high resolution. As shown in the corresponding plots of the wellbore data log 600, a signal of the high-resolution log data 604 includes more details and intricate features than, for example, the signals of the low-resolution log data 606 and 610.

As shown, the resolution transformation system 206 upscales the resolution of the low-resolution log data 606 and 610 to enhance details and identify subtle features corresponding to measurements of the first data type 306 and third data type 310. As described herein, the resolution transformation system 206 generates high-resolution data of the first data type 306 and the third data type 310. For instance, based on the high-resolution log data 604 of the second data type 308 and tool response functions corresponding with the first data type 306 and the third data type 310, the resolution transformation system 206 generates and implements resolution transformation machine learning models to produce high-resolution data.

To illustrate, the resolution transformation system 206 generates a first resolution transformation machine learning model to generate high-resolution log data 608 of the first data type 306 based on the low-resolution log data 606 of the first data type 306. Additionally, resolution transformation system 206 generates a second resolution transformation machine learning model to generate high-resolution log data 612 of the third data type 310 based on the low-resolution log data 610 of the third data type 310. In various implementations, the resolution transformation system 206 may update the wellbore data log 600 with the high-resolution log data 608 and/or the high-resolution log data 612 generated by the resolution transformation machine learning models. In some implementations, high-resolution log data for a data type replaces corresponding low-resolution data or is recorded separately from corresponding low-resolution data.

As shown in FIG. 6, for log entries corresponding to the first data type 306, the high-resolution log data 608 may be based on and/or may exhibit some or all of the features, qualities, and/or data of the low-resolution log data 606, but may include additional detail, nuance, and subtle features over that which the low-resolution log data 606 includes. Similarly, for log entries corresponding to the third data type 310, the high-resolution log data 612 may be based on the low-resolution log data 610 but may similarly include additional detail. In this way, high-resolution data may be generated for data types for which the actual, measured data was of a limited resolution, and the generated high-resolution data may be detailed and accurate based on details and accuracy of the high-resolution log data 604.

In addition, the high-resolution log data 604 may capture certain features, details, events, etc. of the wellbore and underground formations based on the high-resolution with which the data was taken. By training the resolution transformation machine learning models based on the high-resolution log data 604, the high-resolution log data 608 and 612 may be generated to incorporate these same features, details, etc. captured in the high-resolution log data 604, but with respect to and as specifically applicable to the first data type 306 and the third data type 310. In this way, the resolution transformation system 206 may facilitate providing high-resolution data for any or all types of downhole measurement data (in real time and/or after the fact) whether or not the data was measured or recorded in a high resolution.

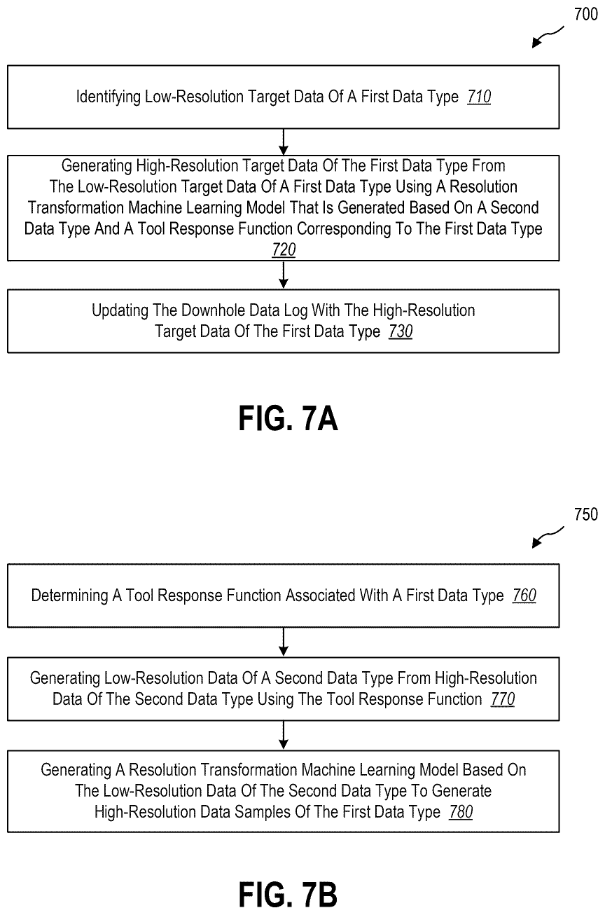

Now turning to FIGS. 7A-7B, each of these figures illustrates an example flowchart that includes a series of acts for using the resolution transformation system according to some implementations. In particular, both FIGS. 7A-7B illustrate an example series of acts representing a computer-implemented method for identifying downhole features using a resolution transformation machine learning model.

While FIGS. 7A-7B each illustrates a series of acts according to one or more implementations, alternative implementations may omit, add to, reorder, and/or modify any of the acts shown. Furthermore, the acts of FIGS. 7A-7B may be performed as part of a method (e.g., a computer-implemented method). Alternatively, a computer-readable medium may include instructions that, when executed by a processing system with a processor, cause a computing device to perform the acts of FIGS. 7A-7B.

In some implementations, a system (e.g., a processing system comprising a processor) may perform the acts of FIGS. 7A-7B. For example, the acts include a system that includes a processing system and computer memory including instructions that, when executed by the processing system, cause the system to perform various actions or steps.

Turning now to FIG. 7A, this figure includes a series of acts 700, with act 710 of identifying low-resolution target data of a first data type. For instance, in example implementations, the act 710 involves identifying low-resolution target data of a first data type from a downhole data log.

As further shown, the series of acts 700 includes act 720 of generating high-resolution target data of the first data type from low-resolution target data of a first data type using a resolution transformation machine learning model that is generated based on a second data type and a tool response function corresponding to the first data type. For instance, in example implementations, the act 720 involves generating high-resolution target data of the first data type using a resolution transformation machine learning model that is generated based on low-resolution source data of a second data type created by applying a tool response function corresponding to the first data type to high-resolution source data of the second data type, wherein the first data type differs from the second data type.

As further shown, the series of acts 700 includes act 730 of updating the downhole data log with the high-resolution target data of the first data type.

In some instances, the series of acts 700 includes additional acts. For example, in some cases, the low-resolution target data of the first data type and the high-resolution source data of the second data type are depth-independent downhole data samples for a wellbore.

In some cases, the series of acts 700 includes identifying a downhole feature indicated in the high-resolution target data of the first data type generated by the resolution transformation machine learning model. For instance, the downhole feature may have a vertical dimension that is missing from the low-resolution target data. In some cases, the downhole feature is a thin-bed pay zone. In some embodiments, the low-resolution target data of the first data type has a first vertical resolution of no more than 2 samples per foot. In various embodiments, the high-resolution target data of the first data type and the high-resolution source data of the second data type each have a second vertical resolution that is at least 1 sample per inch. In various examples, the first data type is not resistivity data, ultrasonic data, or dielectric data and the second data type is resistivity data, ultrasonic data, or dielectric data.

In some embodiments, the resolution transformation machine learning model is generated based on identifying features of the second data type associated with a wellbore of the downhole data log.

In various embodiments, the series of acts 700 includes determining the tool response function from a set of tool response functions based on the first data type. For instance, the resolution transformation machine learning model may be generated based on generating the low-resolution source data of the second data type from the high-resolution source data of the second data type using the tool response function. The low-resolution source data of the second data type may be generated to match a resolution of the low-resolution target data of the first data type.

In some embodiments, the series of acts 700 includes identifying, from a downhole data log a first set of low-resolution data samples of a first data type, a second set of high-resolution data samples of a second data type, and a third set of low-resolution data samples of a third data type. For instance, the first data type, the second data type, and the third data type may differ. In some embodiments, the series of acts 700 includes generating a first set of high-resolution data of the first data type using a first resolution transformation machine learning model from the first set of low-resolution data samples of the first data type. The first resolution transformation machine learning model may be generated to determine resolution transformations for the first data type from the second set of high-resolution data samples of the second data type and a first tool response function associated with the first data type. In some embodiments, the series of acts 700 includes generating a third set of high-resolution data of the third data type using a second resolution transformation machine learning model from the third set of low-resolution data samples of the third data type, wherein the second resolution transformation machine learning model is generated to determine resolution transformations for the third data type from the second set of high-resolution data samples of the second data type and a second tool response function associated with the third data type.

In some embodiments, the first set of low-resolution data samples has a first vertical resolution and the third set of low-resolution data samples has a second vertical resolution different than the first vertical resolution. In various cases, generating the first resolution transformation machine learning model is based on generating a first set of low-resolution training data samples of the second data type at the first vertical resolution from the second set of high-resolution data samples of the second data type using the first tool response function. Generating the second resolution transformation machine learning model may be based on generating a second set of low-resolution training data samples of the second data type at the second vertical resolution from the second set of high-resolution data samples of the second data type using the second tool response function.

In some embodiments, the series of acts 700 includes providing a first set of high-resolution data samples of the first data type generated using the first resolution transformation machine learning model for display via a graphical user interface of a client device and/or providing a third set of high-resolution data samples of the third data type generated using the second resolution transformation machine learning model for display via the graphical user interface of the client device.

Turning now to FIG. 7B, this figure includes a series of acts 750 having the act 760 of determining a tool response function associated with a first data type.

As further shown, the series of acts 750 includes act 770 of generating low-resolution data of a second data type from high-resolution data of the second data type using the tool response function. For instance, in example implementations, the act 770 involves generating low-resolution source data samples of a second data type from high-resolution source data samples of the second data type using the tool response function associated with the first data type.

As further shown, the series of acts 750 includes act 780 of generating a resolution transformation machine learning model based on the low-resolution data of the second data type to generate high-resolution data samples of the first data type. For instance, in example implementations, the act 780 involves generating a resolution transformation machine learning model based on the low-resolution source data samples of the second data type and the high-resolution source data samples of the second data type to generate high-resolution data samples of the first data type from low-resolution data samples of the first data type.

In some cases, the series of acts 750 further includes generating the high-resolution data samples of the first data type from the low-resolution source data samples of the first data type by providing the low-resolution source data samples to the resolution transformation machine learning model. In some embodiments, generating the low-resolution source data samples of the second data type includes interpolating the low-resolution source data samples of the second data type to downscale to a resolution matching the low-resolution data samples of the first data type.

In example implementations, the low-resolution source data samples of the first data type correspond to a first downhole data type of a wellbore. In some cases, the high-resolution source data samples of the second data type correspond to a second downhole data type of the wellbore. In example embodiments, the low-resolution source data samples of the first data type and the high-resolution source data samples of the second data type are depth-independent.

In some embodiments, the series of acts 750 further includes identifying low-resolution target data samples of the first data type from a downhole data log, applying the resolution transformation machine learning model to the low-resolution target data samples of the first data type to generate high-resolution target data samples of the first data type, and updating the downhole data log with the high-resolution target data samples of the first data type.

In various implementations, the resolution transformation machine learning model is a neural network. For example, the resolution transformation machine learning model may be an autoencoder model. In some cases, the resolution transformation machine learning model is a generative adversarial network, or a denoising diffusion probability model.

In some embodiments, the series of acts 750 further includes determining an additional tool response function associated with a third data type, generating additional low-resolution source data samples of the second data type from the high-resolution source data samples of the second data type using the additional tool response function associated with the third data type, and generating an additional resolution transformation machine learning model based on the additional low-resolution source data samples of the second data type and the high-resolution source data samples of the second data type to generate high-resolution data samples of the third data type from low-resolution data samples of the third data type.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may use any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media may include a network and/or data links that carry required program code in the form of computer-executable instructions or data structures, which may be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures may be transferred automatically from transmission media to non-transitory computer-readable storage media (devices), or vice versa. For example, computer-executable instructions or data structures received over a network or data link may be buffered in random-access memory (RAM) within a network interface module (NIC), and then it is eventually transferred to computer system RAM and/or to less volatile computer storage media (devices) at a computer system. Thus, it should be understood that computer-readable storage media (devices) may be included in computer system components that also (or even primarily) use transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media may be any available media that may be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure may include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which may be used to store desired program code means in the form of computer-executable instructions or data structures and which may be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” may include calculating, computing, processing, deriving, investigating, looking up (e.g., looking up in a table, a data repository, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for identifying downhole features, comprising:
identifying low-resolution target data of a first data type from a downhole data log;
generating high-resolution target data of the first data type using a resolution transformation machine learning model that is generated based on low-resolution source data of a second data type created by applying a tool response function corresponding to the first data type to high-resolution source data of the second data type, wherein the first data type differs from the second data type; and
updating the downhole data log with the high-resolution target data of the first data type.

2. The computer-implemented method of claim 1, wherein the low-resolution target data of the first data type and the high-resolution source data of the second data type are depth-independent downhole data samples for a wellbore.

3. The computer-implemented method of claim 1, further comprising identifying a downhole feature indicated in the high-resolution target data of the first data type generated by the resolution transformation machine learning model, wherein the downhole feature has a vertical dimension that is missing from the low-resolution target data.

4. The computer-implemented method of claim 3, wherein the downhole feature is a thin bed pay zone.

5. The computer-implemented method of claim 1, wherein:
the low-resolution target data of the first data type has a first vertical resolution of no more than 2 samples per foot; and
the high-resolution target data of the first data type and the high-resolution source data of the second data type each have a second vertical resolution that is at least 1 sample per inch.

6. The computer-implemented method of claim 1, wherein:
the second data type is resistivity data, ultrasonic data, or dielectric data; and
the first data type is not resistivity data, ultrasonic data, or dielectric data.

7. The computer-implemented method of claim 1, wherein the resolution transformation machine learning model is generated based on identifying features of the second data type associated with a wellbore of the downhole data log.

8. The computer-implemented method of claim 1, further comprising determining the tool response function from a set of tool response functions based on the first data type.

9. The computer-implemented method of claim 1, wherein:
the resolution transformation machine learning model is generated based on generating the low-resolution source data of the second data type from the high-resolution source data of the second data type using the tool response function; and
the low-resolution source data of the second data type is generated to match a resolution of the low-resolution target data of the first data type.

10. A system comprising:
a processing system; and
a computer memory comprising instructions that, when executed by the processing system, cause the system to perform operations of:
determining a tool response function associated with a first data type;
generating low-resolution source data samples of a second data type from high-resolution source data samples of the second data type using the tool response function associated with the first data type; and
generating a resolution transformation machine learning model based on the low-resolution source data samples of the second data type and the high-resolution source data samples of the second data type to generate high-resolution data samples of the first data type from low-resolution data samples of the first data type.

11. The system of claim 10, wherein the operations further comprise generating the high-resolution data samples of the first data type from the low-resolution source data samples of the first data type by providing the low-resolution source data samples to the resolution transformation machine learning model.

12. The system of claim 11, wherein generating the low-resolution source data samples of the second data type includes interpolating the low-resolution source data samples of the second data type to downscale to a resolution matching the low-resolution data samples of the first data type.

13. The system of claim 10, wherein:
the low-resolution source data samples of the first data type correspond to a first data type of a wellbore;
the high-resolution source data samples of the second data type correspond to a second data type of the wellbore; and
the low-resolution source data samples of the first data type and the high-resolution source data samples of the second data type are depth-independent.

14. The system of claim 10, further comprising:
identifying low-resolution target data samples of the first data type from a downhole data log;
applying the resolution transformation machine learning model to the low-resolution target data samples of the first data type to generate high-resolution target data samples of the first data type; and
updating the downhole data log with the high-resolution target data samples of the first data type.

15. The system of claim 10, wherein the resolution transformation machine learning model is an autoencoder neural network model.

16. The system of claim 10, further comprising:
determining an additional tool response function associated with a third data type;
generating additional low-resolution source data samples of the second data type from the high-resolution source data samples of the second data type using the additional tool response function associated with the third data type; and
generating an additional resolution transformation machine learning model based on the additional low-resolution source data samples of the second data type and the high-resolution source data samples of the second data type to generate high-resolution data samples of the third data type from low-resolution data samples of the third data type.

17. A computer-implemented method for identifying downhole features, comprising:
identifying, from a downhole data log:
a first set of low-resolution data samples of a first data type;
a second set of high-resolution data samples of a second data type; and
a third set of low-resolution data samples of a third data type, wherein the first data type, the second data type, and the third data type differ;
generating a first set of high-resolution data of the first data type using a first resolution transformation machine learning model from the first set of low-resolution data samples of the first data type, wherein the first resolution transformation machine learning model is generated to determine resolution transformations for the first data type from the second set of high-resolution data samples of the second data type and a first tool response function associated with the first data type; and
generating a third set of high-resolution data of the third data type using a second resolution transformation machine learning model from the third set of low-resolution data samples of the third data type, wherein the second resolution transformation machine learning model is generated to determine resolution transformations for the third data type from the second set of high-resolution data samples of the second data type and a second tool response function associated with the third data type.

18. The computer-implemented method of claim 17, wherein the first set of low-resolution data samples has a first vertical resolution and the third set of low-resolution data samples has a second vertical resolution different than the first vertical resolution.

19. The computer-implemented method of claim 18, wherein:
generating the first resolution transformation machine learning model is based on generating a first set of low-resolution training data samples of the second data type at the first vertical resolution from the second set of high-resolution data samples of the second data type using the first tool response function; and
generating the second resolution transformation machine learning model is based on generating a second set of low-resolution training data samples of the second data type at the second vertical resolution from the second set of high-resolution data samples of the second data type using the second tool response function.

20. The computer-implemented method of claim 17, further comprising:
providing a first set of high-resolution data samples of the first data type generated using the first resolution transformation machine learning model for display via a graphical user interface of a client device; or
providing a third set of high-resolution data samples of the third data type generated using the second resolution transformation machine learning model for display via the graphical user interface of the client device.
